(19) United States
(12) Patent Application Publication
(10) Pub. No.: US 2007/0274302 A1
(43) Pub. Date: Nov. 29, 2007

(54) Data Storage Device, Memory Managing Method, and Program

(76) Inventor: Shigeru Moriya, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/751,113

(22) Filed: May 21, 2007

(30) Foreign Application Priority Data
May 24, 2006 (JP) 2006-144616

(51) Int. Cl. H04L 12/50

(52) U.S. Cl. 370/360

(57) ABSTRACT

A data storage device includes a memory, a record controller, and a management area setting unit. The method has first and second management areas for recording address information indicative of valid data areas, and a security area for recording information corresponding to address information recorded in either one of the first and second management areas. The record controller rewrites information recorded in the security area after the address information recorded in either one of the first and second management areas has been updated, into information corresponding to the updated address information. The management area setting unit sets either one of the first and second management areas as a valid management area based on the information recorded in the security area.

### CROSS REFERENCES TO RELATED APPLICATIONS

The present invention contains subject matter related to Japanese Patent Application JP 2006-144616 filed in the Japan Patent Office on May 24, 2006, the entire contents of which being incorporated herein by reference.

### BACKGROUND OF THE INVENTION

1. Field of the Invention

The present invention relates to a data storage device, a memory managing method, and a program.

2. Description of the Related Art

Usually, communication devices capable of performing noncontact communications, typically cellular phone units incorporating noncontact IC (Integrated Circuit) cards or noncontact IC chips, have memories for storing data exchanged with readers/writers and applications for performing processes demanded to provide services. These memories are classified into volatile memories for use as buffers or the like and nonvolatile memories for recording user data and applications therein.

Generally, it is known in the art that it takes a relatively long time to record data and applications in nonvolatile memories. If it is assumed that a nonvolatile memory is used in a communication device, then when the power supplied to the nonvolatile memory is cut off or a communication session on the communication device is interrupted prior to its completion while information is being written into the nonvolatile memory, there is a need for restoring means for restoring the recorded data from the nonvolatile memory. To meet such a need, there have been devised and disclosed restoring means for restoring data by holding old data to be rewritten and writing new data into another memory area, so that even when the writing of the new data is interrupted before it is completed, the prior data state can be restored based on the old data. For details, reference should be made to Japanese Patent Laid-Open No. 2001-51883, Japanese Patent Laid-Open No. 2001-249855, Japanese Patent Laid-Open No. Hei 8-272698, and Japanese Patent Laid-Open No. 2005-107608, for example.

### SUMMARY OF THE INVENTION

The existing data writing means fail to determine whether new data have reliably been recorded in the nonvolatile memory or not. If the power supplied to the nonvolatile memory is interrupted while data are being written into the nonvolatile memory, then when the nonvolatile memory is activated next time, it needs to transit to a state prior to the writing of the data or a state subsequent to the completion of the writing of the data. As described above, it takes the nonvolatile memory a certain period of time until data are recorded into the nonvolatile memory. Therefore, even if data appear to be recorded in the nonvolatile memory, the data may not be reliably recorded in the nonvolatile memory, but may be in an unstable state. Accordingly, a need has arisen for means for detecting whether data have reliably been recorded in a nonvolatile memory or not.

It is desirable to provide a data storage device, a memory managing method, and a program which are capable of increasing the safety and reliability of the storage of data into a memory.

According to an embodiment of the present invention, there is provided a data storage device including a memory configured to have first and second management areas for recording address information indicative of valid data areas, and a security area for recording information corresponding to address information recorded in either one of the first and second management areas, a record controller configured to rewrite information recorded in the security area after the address information recorded in either one of the first and second management areas has been updated, into information corresponding to the updated address information, and a management area setting unit configured to set either one of the first and second management areas as a valid management area based on the information recorded in the security area.

As described above, the memory has the first and second management areas for recording address information indicative of valid data areas, and the security area for recording information corresponding to address information recorded in either one of the first and second management areas. The record controller rewrites information recorded in the security area after the address information recorded in either one of the first and second management areas has been updated, into information corresponding to the updated address information. The management area setting unit sets either one of the first and second management areas as a valid management area based on the information recorded in the security area. Therefore, it is possible to determine whether the address information recorded in either one of the first and second management areas has reliably been updated or not, based on the information held by the security area. The data storage device is thus highly resistant to faults due to an unexpected power failure or the like, and makes stored data highly reliable.

The record controller may invalidate the address information recorded in one of the first and second management areas which is not set as the valid management area, after the information recorded in the security area has been rewritten. It is thus possible to determine whether the recording of the information into the security area has been completed or not, based on the state of the management area which is not set as a valid management area.

The management area setting unit may determine whether the security area is valid or not based on whether the first management area or the second management area is invalidated or not, when the data storage device is activated. It is thus possible to perform a data restoring process after it is determined whether the rewriting of the information in the security area is completed or not. As a result, highly reliable data restoring means is provided.

The memory may further include a plurality of auxiliary management areas for recording address information indicative of valid data areas, the first and second management areas and the security area. The first management area or the second management area may record address information indicative of a valid auxiliary management area instead of address information indicative of a valid data area. With this arrangement, a memory having management areas of a hierarchical structure provides data storage means which is highly resistant to faults due to an unexpected power failure or the like, and makes stored data highly reliable.

According to another embodiment of the present invention, there is also provided a method of managing data in a memory having first and second management areas for recording address information indicative of valid data areas, and a security area for recording information corresponding to address information recorded in either one of the first and second management areas, the method including the steps of updating address information recorded in either one of the first and second management areas, rewriting information recorded in the security area into information corresponding to the updated address information, and setting either one of the first and second management areas as a valid management area based on the information recorded in the security area.

In the memory having the first and second management areas for recording address information indicative of valid data areas, and the security area for recording information corresponding to address information recorded in either one of the first and second management areas, address information recorded in either one of the first and second management areas is updated in the first step. Then, in the second step, information recorded in the security area is rewritten into information corresponding to the updated address information. In the third step, either one of the first and second management areas is set as a valid management area based on the information recorded in the security area. It is thus possible to determine whether the address information recorded in either one of the first and second management areas has reliably been updated or not, by checking the information recorded in the security area against the address information recorded in either one of the first and second management areas. As a result, the method of management data is highly resistant to faults due to an unexpected power failure or the like, and makes stored data highly reliable.

According to still another embodiment of the present invention, there is also provided a program for managing data in a memory having first and second management areas for recording address information indicative of valid data areas, and a security area for recording information corresponding to address information recorded in either one of the first and second management areas, the program enabling a computer to performing the functions of updating address information recorded in either one of the first and second management areas, rewriting information recorded in the security area into information corresponding to the updated address information, and setting either one of the first and second management areas as a valid management area based on the information recorded in the security area.

In the memory having the first and second management areas for recording address information indicative of valid data areas, and the security area for recording information corresponding to address information recorded in either one of the first and second management areas, address information recorded in either one of the first and second management areas is updated according to the first function. Then, according to the second function, information recorded in the security area is rewritten into information corresponding to the updated address information. According to the third function, either one of the first and second management areas is set as a valid management area based on the information recorded in the security area. It is thus possible to determine whether the address information recorded in either one of the first and second management areas has reliably been updated or not, by checking the information recorded in the security area against the address information recorded in either one of the first and second management areas. As a result, the memory management program is highly resistant to faults due to an unexpected power failure or the like, and makes stored data highly reliable.

According to embodiments of the present invention, as described above, the data stored in the memory are highly secure and reliable.

### BRIEF DESCRIPTION OF THE DRAWINGS

FIG. 1 is a block diagram of a communication device according to a first embodiment of the present invention;

FIG. 2 is a block diagram of a memory manager of the communication device according to the first embodiment;

FIGS. 3A and 3B are block diagrams of a memory of the communication device according to the first embodiment;

FIG. 4 is a flowchart of a processing sequence of a memory managing method according to the first embodiment;

FIG. 5 is a flowchart of another processing sequence of the memory managing method according to the first embodiment;

FIG. 6 is a flowchart of still another processing sequence of the memory managing method according to the first embodiment;

FIG. 7 is a block diagram of a memory according to a second embodiment of the present invention; and

FIG. 8 is a flowchart of a processing sequence of a memory managing method according to the second embodiment.

### DETAILED DESCRIPTION OF THE PREFERRED EMBODIMENTS

Preferred embodiments of the present invention will be described in detail below with reference to the accompanying drawings. Like or corresponding parts are denoted by like or corresponding reference characters throughout views.

### First Embodiment

A communication device having a data storage device according to a first embodiment of the present invention, a data updating method, and a method of determining a recorded state will be described in detail below. Though a communication device will be described as a device having a data storage device according to an embodiment of the present invention, the data storage device may be any of various electronic devices capable of storing data of personal computers, PDAs (Personal Digital Assistants), information-intensive home appliances, wrist watches, music players, video players, etc., for example. In the description, a noncontact IC card will be described as an example of the communication device. However, the communication device may be a cellular phone unit or another electronic device incorporating a noncontact IC chip.

(Structure of the Communication Device)

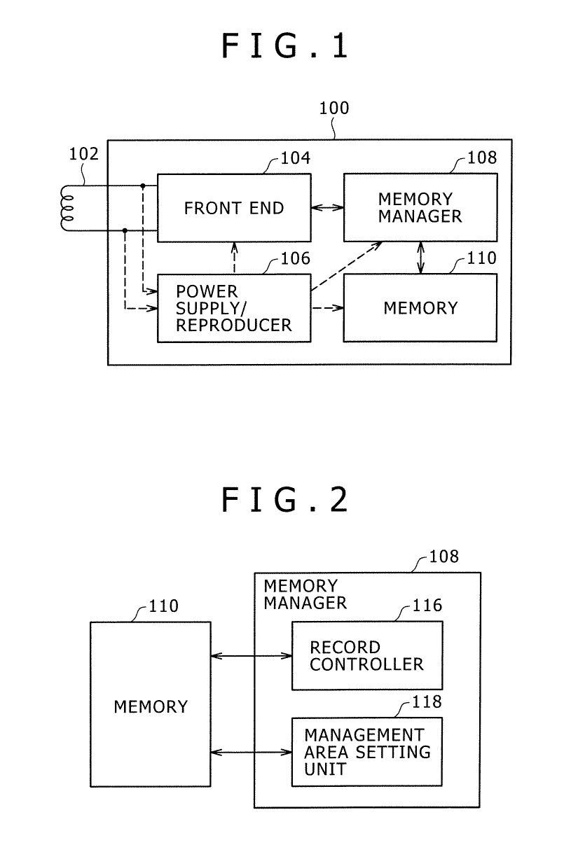

First, a communication device having a data storage device according to the present embodiment will be described below with reference to FIG. 1. FIG. 1 shows the communication device in block form.

As shown in FIG. 1, a communication device 100 in the form of a noncontact IC card has an antenna 102, a front end 104, a power supply/reproducer 106, a memory manager 108, and a memory 110. The antenna 102 provides means for transmitting data to and receiving data from a reader/writer (not shown) for the noncontact IC card. The antenna 102 includes a loop antenna, for example, which transmits data to and receives data from the reader/writer and is supplied with electric power from the reader/writer based on electromagnetic induction.

The front end 104 frequency-divides a carrier transmitted from the reader/write, reproducing a clock signal for driving a logic controller (not shown) and the memory manager 108. The power supply/reproducer 106 reproduces electric power from the carrier received by the antenna 102 and supplies the electric power to the components of the communication device 100. When the memory manager 108 writes data transmitted from the front end 104 into the memory 110, the memory manager 108 specifies a data area and a management area in the memory 110, and records the data in the specified data and management areas. The memory manager 108 also controls those memory areas to become valid or invalid. The memory 110 records programs for operating the communication device 100 and data received from the reader/writer. The memory 110 includes a plurality of data areas for recording data and a management area for holding address information for valid ones of all the data areas. The management area is divided into a plurality of areas. The memory 110 and the memory manager 108 of the communication device 100 provide the data storage device according to the present embodiment. Therefore, structural details and functions of the memory 110 and the memory manager 108 will be described below.

First, the structural details of the memory manager 108 will be described below. The memory manager 108 includes a record controller 116 and a management area setting unit 118.

The record controller 116 records various data in the data areas or the management areas of the memory 110. For example, the record controller 116 may record user data received from the reader/writer into the data areas, or may record address information for valid ones of all the data areas into the management areas. When the record controller 116 records address information into the management areas, it selects a management area and writes the address information into the selected management area. Particularly, for updating address information recorded in a management area, the record controller 116 holds the address information before it is updated, and controls the recording of the address information into the management area so that even if the address information is corrupted while it is being written, the functions of the communication device 100 can be restored to their original state based on the address information prior to being updated. As described below, the memory 110 also has a security area for recording information corresponding to the address information that has been recorded in any one of the management areas. The record controller 116 also controls the recording of information in the security area.

The management area setting unit 118 sets either one of the management areas in the memory 110 as a valid management area based on the information recorded in the security area. If it is assumed that address information prior to being updated is recorded in a first management area and address information recorded in a second management area is updated, then when the updating process is properly completed, the security area holds information corresponding to the address information that has been recorded in the second management area. At this time, the management area setting unit 118 confirms that the address information recorded in the second management area and the information recorded in the security area coincide with each other, and sets the second management area as a valid management area. If the updating process is interrupted while the address information is being written into the second management area, then the security area holds the address information prior to being updated. At this time, the management area setting unit 118 confirms that the information recorded in the security area and the address information recorded in the first management area coincide with each other, and sets the first management area as a valid management area. As described above, the management area setting unit 118 checks the information recorded in the security area against the address information recorded in the first or second management area, and sets the management area which stores the address information in conformity with the information recorded in the security area, as a valid management area.

The management area setting unit 118 operates similarly if three or more management areas are available. For example, for updating address information recorded in plural ones of three management areas, the address information in all the management areas that are demanded to be updated among the first through third management areas is updated, and thereafter information corresponding to the updated address information is recorded in the security area. Therefore, the management area setting unit 118 checks the information recorded in the security area against the address information recorded in the first through third management areas, and sets the management area which stores the address information in conformity with the information recorded in the security area, as a valid management area.

The updating process of updating the address information recorded in the second management area while the first management area is holding the address information prior to being updated has been described above. For further updating the address information, the address information recorded in the first management area is rewritten into the updated address information, and information corresponding to the updated address information in the first management area is recorded into the security area. For example, the record controller 116 alternately updates the address information successively in the first management area and the second management area. Specifically, if the memory 110 has two management areas, the record controller 116 alternately updates the address information held by the first management area and the address information held by the second management area. The record controller 116 records the updated address information into the security area each time the address information in the first or second management area is updated.

The record controller 116 and the management area setting unit 118 have been described above with respect to the updating of address information in the first and second management areas. The management areas in the memory 110 have an identical functional arrangement, and hence the address information recorded in one of the management areas and the address information recorded in the other management area are successively updated according to the same updating process. The memory 110 also has the security area in addition to the management areas, and the security area stores updated address information each time the address information recorded in either one of the management areas is updated.

(Structure of the Memory 110)

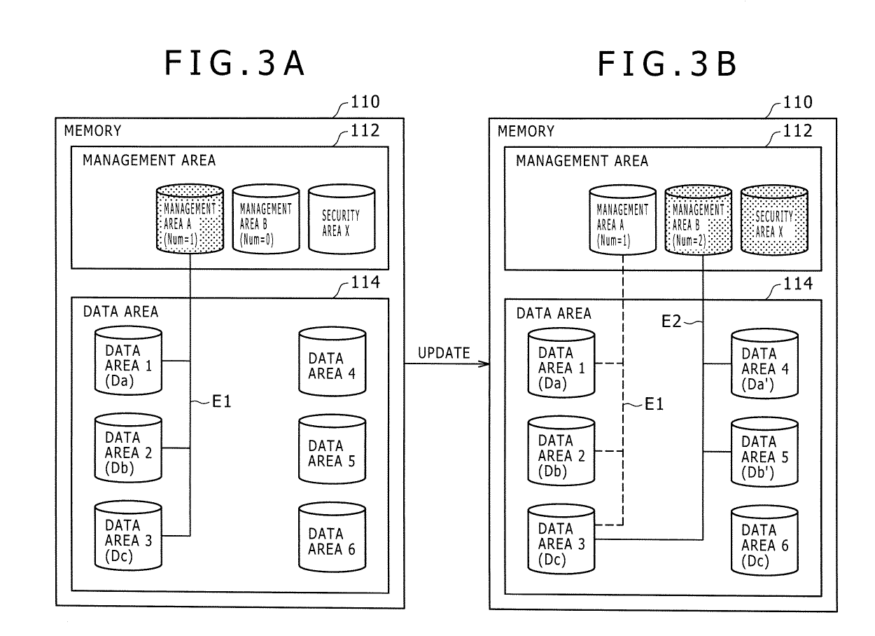

Structural details of the memory 110 will be described in detail below with reference to FIG. 3. As shown in FIG. 3, the memory 110 has a management area 112 and a data area 114. The management area 112 is divided into a plurality of areas including, for example, a management area A, a management area B, and a security area X. The management area A corresponds to the first management area referred to above, and the management area B to the second management area referred to above. The security area X is an area for recording information which is the same as the information recorded in the management area A or the management area B. When data recorded in the management area A or the management area B is updated, data corresponding to the updated data is recorded into the security area X. The data recorded in the security area X may be the same as the updated data in the management area A or the management area B, or may be data capable of identifying the updated data.

For example, it is assumed that address information recorded in the management area A is to be updated by other address information. The record controller 116 may record information capable of identifying the other address information into the security area X. Specifically, after the address information recorded in the management area A as the first management area is updated, the information recorded in the security area X is rewritten into information corresponding to the updated address information. More specifically, since information capable of confirming that the other address information is reliably recorded in the management area A may be recorded in the security area X, part of the other address information may be recorded in the security area X or an error checking code (e.g., parity information) for the other address information may be recorded in the security area X. The record controller 116 may record the other address information directly into the security area X. Each of the management areas A, B has a write counter (indicated by “Num” in FIGS. 3A and 3B) for determining whether the address information stored therein is new or old. When the address information stored in the management area A or B is updated, the memory manager 108 updates the write counter of the updated management area A or B up to a maximum value in the management area 112.

The data area 114 is divided into data areas 1 through 6. These divided data areas provide a redundant structure with respect to each other when data stored therein is updated. Specifically, for updating data stored in a data area, the memory manager 108 selects a free data area from the divided data areas, stores updated data into the selected data area, and thereafter erases the old data. With such a redundant structure, even when the memory 110 suffers unexpected trouble such as a power failure while stored data is being updated, the original recorded data state can be restored based on the old data that is held.

It will be assumed in the description which follows that the management area 112 includes two divided management areas A, B and one security area X and the data area 114 includes six data areas. However, the memory 110 according to the present embodiment is not limited to such a configuration. The management area 112 may be divided into three or more management areas, and the data area 114 may be divided into two or more data areas. The memory 110 may have two or more security areas.

(Data Updating Method)

A process of updating data recorded in the memory 110 will be described below with reference to FIGS. 3A and 3B. As shown in FIG. 3A, data Da is stored in the data area 1, data Db in the data area 2, and data Dc in the data area 3, and the management area A is valid. The solid line E1 indicates valid data areas, and the management area A stores address information of the data areas 1, 2, 3 that are valid. The write counter of the management area A is set to Num=1. Since the count of the write counter of the management area A is of a maximum value in the management area 112, the management area A is a management area storing latest address information.

It is assumed as shown in FIG. 3B that the data Da stored in the data area 1 and the data Db stored in the data area 2 are to be updated respectively into data Da′ and data Db′. For updating the data, the record controller 116 does not overwrite the data stored in the data areas 1, 2, but writes the data Da′ and the data Db′ respectively into the data areas 4, 5 which are free data areas, in order to prevent the existing data from being accidentally lost. Thereafter, the record controller 116 records address information indicative of valid data areas E2 into the management area B. After the address information has been recorded into the management area B, the memory manager 108 increments the write counter of the management area B. Specifically, the memory manager 108 sets the write counter of the management area B to a count Num=2 (see FIG. 3B) which is the sum of 1 and the count Num=1 of the write counter of the management area A which held the latest address information before the data was updated (see FIG. 3A). In other words, when the address information is updated, the memory manager 108 sets the write counter whose count is represented by the sum of 1 and the maximum count of the write counter in the management area 112 before the data was updated, as the write counter of the management area storing the updated address information. Consequently, the management area having the write counter with the maximum count in the management area 112 holds the latest address information.

The record controller 116 then records address information indicative of the data area 3, the data area 4, and the data area 5 into the management area B. After the updating of the address information in the management area B is completed, the record controller 116 records information corresponding to the updated address information into the security area X. For example, the record controller 116 may record address information which is the same as the address information recorded in the management area B into the security area X or may record other information capable of identifying the updated address information recorded in the management area B into the security area X.

According to the above method, when the address information recorded in the management area B is updated, the memory manager 108 checks the information recorded in the redundant security area X against the address information recorded in the management area B whose write counter has the maximum count, for thereby confirming that the address information has reliably been written into the management area B.

Since the information is written according to the above method, when the data of the memory 110 is read after the address information is updated, the memory manager 108 can determine whether the updated address information has reliably been recorded in the management area B or not. However, if the recording of information into the security area X is not finished due to a power failure or the like while the information is being recorded into the security area X, it is difficult for the memory manager 108 to determine whether the address information in the management area B is correct or wrong based on the state of the security area X.

According to the present embodiment, the memory manager 108 invalidates the information held by the management area A in which the old address information is recorded, after the recording of the information into the security area X is completed. The management area A, the management area B, and the security area X hold CRC (Cyclic Redundancy Check) information as a data verifying code. The information held by the management area A may be invalidated by overwriting the CRC information in the management area A with an invalid value or by overwriting the information held by the management area A with a value such as 0xf or the like, thereby deleting the information held by the management area A. This process makes it possible for the memory manager 108 to detect the recorded state of the security area X when the data in the memory 110 is read again. Specifically, when the data in the memory 110 is read, the memory manager 108 refers to the state of the management area A whose write counter has a small count, and if the information in the management area A is invalidated, the memory manager 108 can detect that the security area X is in a stable recorded state. Conversely, if the information in the management area A is not invalidated, then the management area setting unit 118 checks the information held by the security area X against the address information held by the management area A or B, and can select a management area to be validated. The management area setting unit 118 sets either the management area A or the management B as a valid management area based on the information recorded in the security area X. If it is judged that the information held by the security area X and the address information held by the management area A coincide with each other or are identical to each other, then the management area setting unit 118 sets the data area indicated by the address information recorded in the management area A as a valid data area.

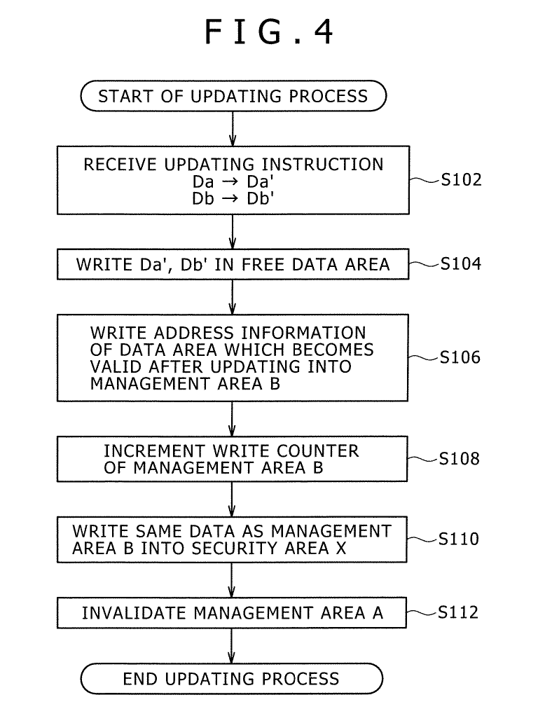

The above updating process will be described in detail below with reference to a flowchart shown in FIG. 4. The communication device 100 receives an updating instruction for updating the data in the data area 114 in step S102. The record controller 116 writes received data into a free data area in the data area 114 in step S104. Thereafter, the record controller 116 writes address information indicative of the position of a data area which becomes valid after the data is updated, into the management area B in step S106. The memory manager 108 increments the write counter of the management area B in step S108. After the recording of the address information into the management area B is completed, the record controller 116 writes information which is the same as the address information recorded in the management area B into the security area X in step S110. After the writing of the information into the security area X is completed, the memory manager 108 invalidates the management area A which has held the old address information in step S112.

When the updating process is properly completed, the security area X stores the same address information as the address information recorded in the management area B, and the management area A has its address information invalidated. If the updating process is interrupted while the address information is being recorded into the security area X, then the management area A keeps the old address information. In this case, the memory manager 108 can restore a valid data area to the state prior to being updated, using the old address information. If the updating process is interrupted while the address information in the management area B is being updated, then since the security area X stores the address information prior to being updated which is recorded in the management area A, the memory manager 108 confirms the coincidence between the information in the security area X and the information in the management area A, and can restore a valid data area using the address information prior to being updated. With the above memory configuration, therefore, the recorded data can be managed with better safety.

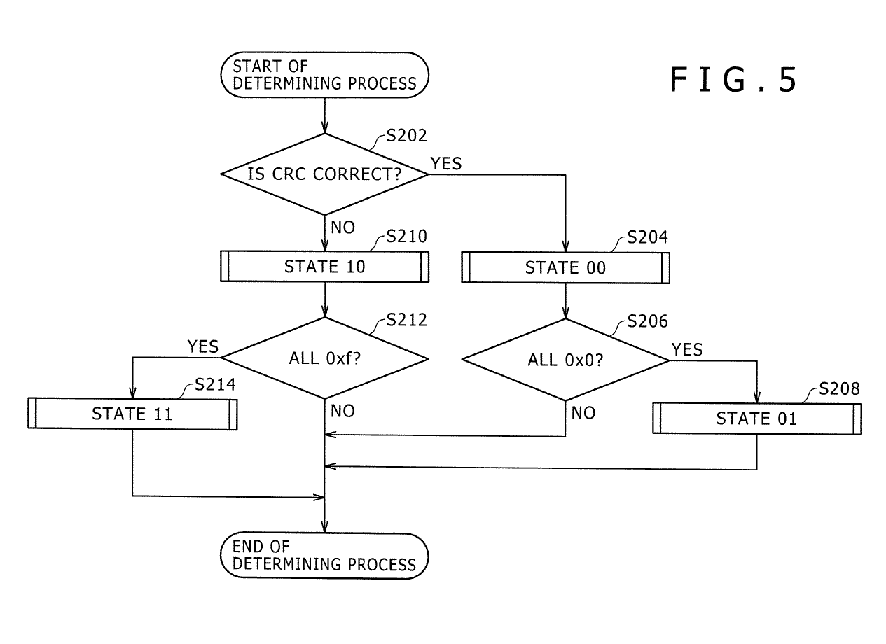

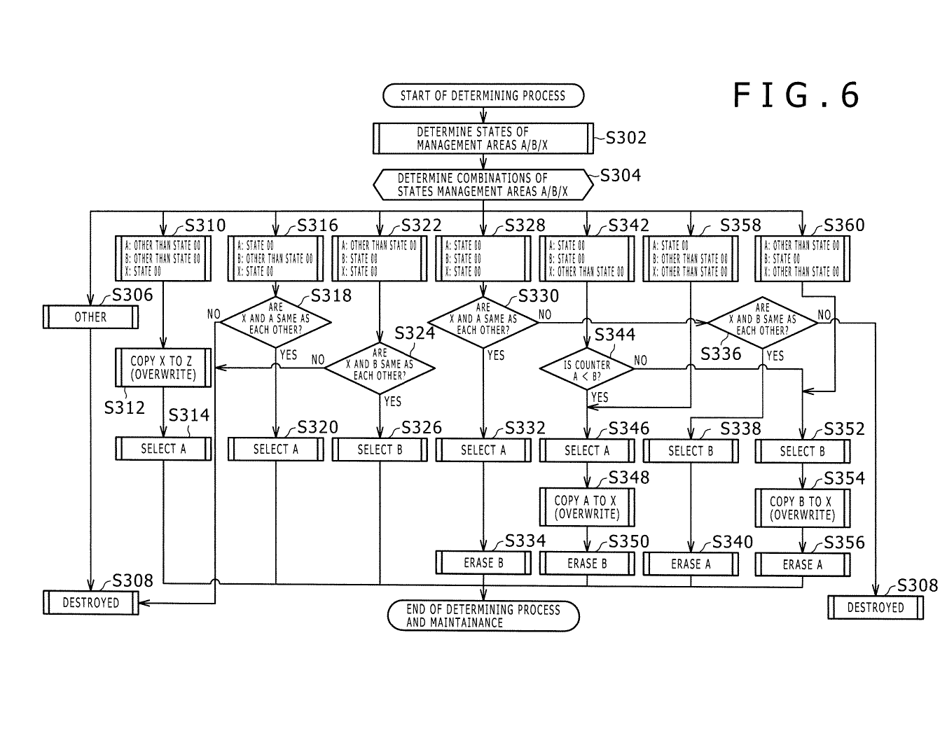

The process of recording data has been described above. Now, a process of determining the states of management areas in a data reading process, and a data restoring process will be described below with reference to FIGS. 5 and 6. As described above, the data storage device can update data or restore data safely by recording address information into the redundant security area X and invalidating address information in an invalid management area. However, depending on the time when the recording process is interrupted due to a power failure or the like, an unexpected accident such as the destruction of a certain management area may occur after elapse of a certain period of time. For example, information which has been recorded over a sufficiently long period of time may be lost because of a physical shock applied to the data storage device. Means for detecting the state of each management area and a method of determining the recorded state thereof will be described below.

First, a process of determining the state of each management area will be described below with reference to a flowchart shown in FIG. 5. This process is often performed when the communication device 100 is activated because a restoring process needs to be carried out when the power supply is cut off or the communication process is interrupted while the data is being updated as described above. The state determining process to be described below is carried out similarly on the management areas A, B and the security area X in the management area 112.

First, the memory manager 108 confirms whether the CRC information held by a management area is correct or wrong in step S202. If the CRC information is correct, then the memory manager 108 judges that the management area is in a state 00 in step S204. The state 00 represents the correct CRC information. Since the memory manager 108 recognizes that the CRC information is correct if all the recorded information is 0x0 (an error state), the memory manager 108 further determines whether all the recorded information is 0x0 or not in step S206. If all the recorded information is 0x0, then the memory manager 108 judges that the management area is in a state 01 in step S208. Otherwise, the memory manager 108 judges that the management area is in the state 00, and the state determining process is put to an end. The state 01 represents an incorrect state in which all the recorded information is 0x0.

If the CRC information is incorrect in step S202, then the memory manager 108 judges that the management area is in a state 10 in step S210. The state 10 represents the incorrect CRC information. A state in which all the information held by the management area is 0xf represents an erased state. Therefore, the memory manager 108 determines whether all the recorded information is 0xf or not in step S212. If all the recorded information is 0xf, then the memory manager 108 judges that the management area is in a state 11 in step S214. Otherwise, the memory manager 108 judges that the management area is in the state 10, and the state determining process is put to an end. The state 11 represents a state in which all the recorded information is 0xf. As described above, the memory manager 108 determines the states of all the management areas A, B and the security area X when the data storage device is activated. The judged state indicates whether the management area is normal or not. Even when the address information recorded in the management area is not corrupted, if the information recorded in the management area is invalidated, the memory manager 108 judges that the management area is not normal.

A process of selecting a valid management area based on the state of each management area as determined by the above state determining process will be described below with reference to FIG. 6. FIG. 6 is a flowchart of a processing sequence for selecting a valid management area. In the state determining process shown in FIG. 5, various different states are determined. In the process shown in FIG. 6, however, a valid management area is selected based on only whether each management area is in the state 00 (normal state) or not.

The memory manager 108 determines the state of each management area by performing state determining process shown in FIG. 5 on the management areas A, B and the security area X in step S302. Then, the memory manager 108 refers to the determined states of the management areas, and determines combinations of the states in step S304. FIG. 6 illustrates all possible combinations of the states which include combinations that occur rarely in the usual environment in which the data storage device is used.

First, it is assumed that all the management area A, the management area B, and the security area X are other than in the state 00 in step S306. In this state, the memory 110 suffers physical damage, or the memory manager 108 is faulty, or the memory 110 is in an incorrect state for other reasons in step S308. Therefore, the communication device 100 should not be used as the data stored in the memory 110 is corrupted or invalid.

It is assumed that the management area A and the management area B are other than in the state 00 and the security area X is in the state 00 in step S310. In this case, the record controller 116 copies the information in the security area X to the management area A by overwriting the information in the management area A in step S312. The management area setting unit 118 selects the management area A as a valid management area in step S314, after which the valid management area determining process is put to an end. In step S312, the record controller 116 may copy the information in the security area X to the management area B by overwriting the information in the management area B. In this case, the management area setting unit 118 selects the management area B as a valid management area, after which the valid management area determining process is put to an end.

It is assumed that the management area A and the security area X are in the state 00 and the management area B is other than in the state 00 in step S316. In this case, the memory manager 108 determines whether the information in the security area X and the information in the management area A are the same as each other or not in step S318. If the information in the security area X and the information in the management area A are the same as each other, then the management area setting unit 118 selects the management area A as a valid management area in step S320, after which the valid management area determining process is put to an end. If the information in the security area X and the information in the management area A are different from each other, then since the data is corrupted or invalid in step S308, the communication device 100 should not be used.

It is assumed that the management area A is other than in the state 00 and the management area B and the security area X are in the state 00 in step S322. In this case, the memory manager 108 determines whether the information in the security area X and the information in the management area B are the same as each other or not in step S324. If the information in the security area X and the information in the management area B are the same as each other, then the management area setting unit 118 selects the management area B as a valid management area in step S326, after which the valid management area determining process is put to an end. If the information in the security area X and the information in the management area B are different from each other, then since the data is corrupted or invalid in step S308, the communication device 100 should not be used.

It is assumed that all the management area A, the management area B, and the security area X are in the state 00 in step S328. In this state, the memory manager 108 determines whether the information in the security area X and the information in the management area A are the same as each other or not in step S330. If the information in the security area X and the information in the management area A are the same as each other, then the management area setting unit 118 selects the management area A as a valid management area in step S332. The record controller 116 erases the information in the management area B in step S334. If the information in the security area X and the information in the management area A are different from each other, then the memory manager 108 determines whether the information in the security area X and the information in the management area B are the same as each other or not in step S336. If the information in the security area X and the information in the management area B are the same as each other, then the management area setting unit 118 selects the management area B as a valid management area in step S338. The record controller 116 erases the information in the management area A in step S340. If the information in the security area X and the information in the management area B are different from each other, then since the data is corrupted or invalid in step S308, the communication device 100 should not be used.

It is assumed that the management area A and the management area B are in the state 00 and the security area X are other than in the state 00 in step S342. In this case, the memory manager 108 compares the numerical values, i.e., the counts, of the write counters of the management areas A, B with each other. If the count (Wa) of the write counter of the management area A is smaller than the count (Wb) of the write counter of the management area B (Wa<Wb), then the management area setting unit 118 selects the management area A as a valid management area in step S346. The record controller 116 copies the information in the management area A to the security area X by overwriting the information in the security area X in step S348. The record controller 116 then erases the information in the management area B in step S350, after which the valid management area determining process is put to an end. If the count (Wa) of the write counter of the management area A is greater than the count (Wb) of the write counter of the management area B (Wa>Wb), then the management area setting unit 118 selects the management area B as a valid management area in step S352. The record controller 116 copies the information in the management area B to the security area X by overwriting the information in the security area X in step S354. The record controller 116 then erases the information in the management area A in step S356, after which the valid management area determining process is put to an end.

It is assumed that the management area A is in the state 00 and the management area B and the security area X are other than in the state 00 in step S358. In this case, the management area setting unit 118 selects the management area A as a valid management area in step S346. the record controller 116 copies the information in the management area A to the security area X by overwriting the information in the security area X in step S348. The record controller 116 then erases the information in the management area B in step S350, after which the valid management area determining process is put to an end.

It is assumed that the management area A and the security area X are other than in the state 00 and the management area B is in the state 00 in step S360. In this case, the management area setting unit 118 selects the management area B as a valid management area in step S352. the record controller 116 copies the information in the management area B to the security area X by overwriting the information in the security area X in step S354. The record controller 116 then erases the information in the management area A in step S356, after which the valid management area determining process is put to an end.

As described in detail above with reference to FIG. 6, the management area setting unit 118 determines a management area which is holding normal address information, based on the state of each management area, and can select a valid management area. Therefore, even in the event of a data write failure due to trouble occurring in the data recording process, the memory manager 108 can restore data appropriately.

### Second Embodiment

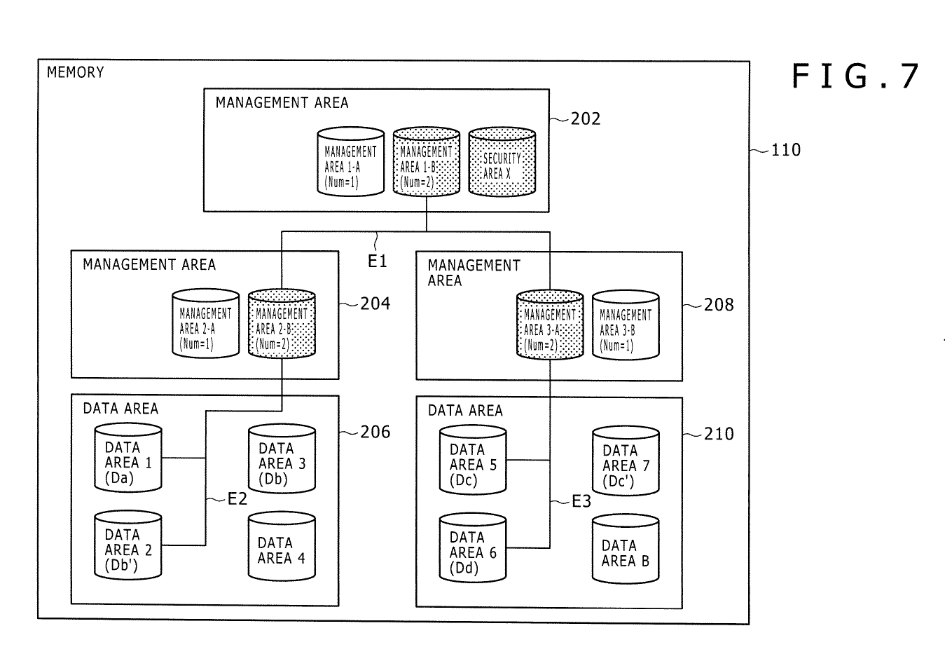

A data storage device according to a second embodiment of the present invention will be described below. Those parts of the data storage device according to the second embodiment which are identical to those of the data storage device according to the first embodiment will not be described in detail below, and only those parts of the data storage device according to the second embodiment which are different from those of the data storage device according to the first embodiment will be described below. The differences between a memory 110 according to the second embodiment and the memory 110 according to the first embodiment will be described below with reference to FIG. 7.

As shown in FIG. 7, the memory 110 according to the second embodiment has a plurality of management areas 202, 204, 208 arranged in a hierarchical structure such that the management areas 204, 208 are subordinate to the management area 202. The memory 110 also has data areas 206, 210 which are subordinate to the management areas 204, 208, respectively. The data area 206 is divided into data areas 1, 2, 3, 4, and the data area 210 into data areas 5, 6, 7, 8. The management area 202 has a management area 1-A, a management area 1-B, and a security area X. The management area 204 has a management area 2-A and a management area 2-B, and the management area 208 has a management area 3-A and a management area 3-B. The management area 1-A corresponds to the first management area referred to above, and the management area 1-B to the second management area referred to above. The management areas 204, 208 differ from the management area 112 according to the first embodiment in that they lack the redundant security area X. The information managed by the management area 202 is address information E1 indicative of a valid management area among the management areas in the management areas 204, 208, unlike the management area 112 according to the first embodiment.

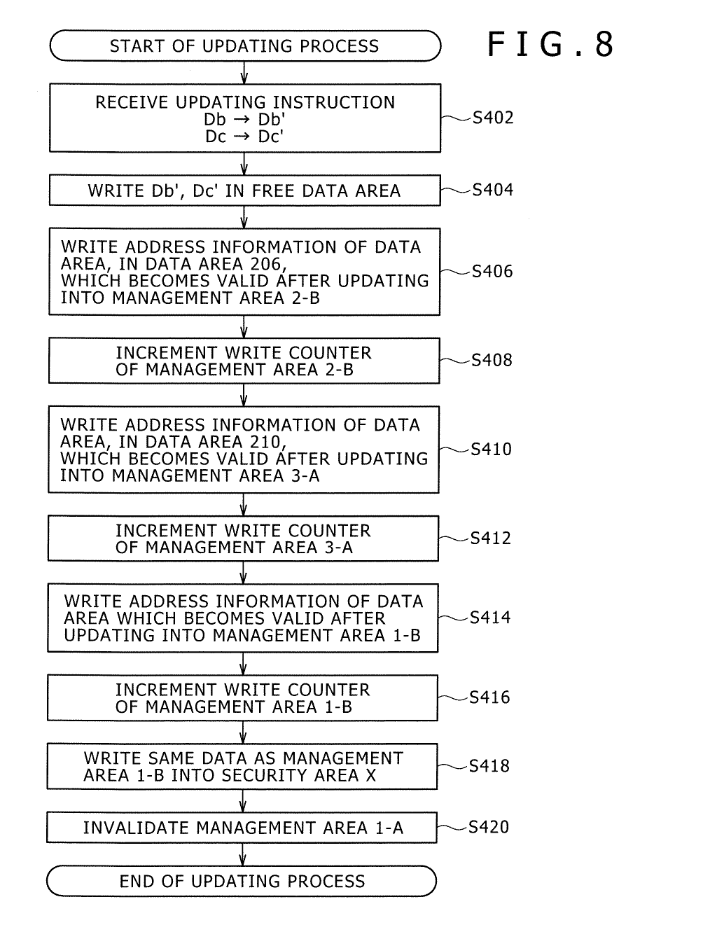

The above differences are primary differences between the memory 110 according to the second embodiment and the memory 110 according to the first embodiment. The structure of the communication device and a method of determining a recorded state are essentially identical to those according to the first embodiment, and will not be described in detail below. A method of updating data in the memory 110 according to the second embodiment will be described below with reference to FIGS. 7 and 8.

(Data Updating Method)

FIG. 7 shows in block form updated data stored in the memory 110. Before the data is updated, data Da is stored in the data area 1, data Db in the data area 3, data Dc in the data area 5, and data Dd in the data area 6, and the management areas 1-A, 2-A, 3-B are valid. The method of updating data in the memory 110 according to the second embodiment to update the data Db stored in the data area 3 into data Db′ and the data Dc stored in the data area 5 into data Dc′ will be described below.

First, the record controller 116 writes the data Db′ and the data Dc′ respectively into the data area 2 and the data area 7, which are free data areas before the data are updated. The record controller 116 then writes address information E2 indicative of a valid data area after the data are updated into the management area 2-B and writes address information E3 indicative of a valid data area after the data are updated into the management area 3-A. Thereafter, the memory manager 108 increments the write counters of the management area 2-B and the management area 3-A to a count Num=2. The record controller 116 records address information E1 indicative of valid management areas of the management areas 204, 208 into the management area 1-B. The memory manager 108 then increments the write counter of the management area 1-B to a count Num=2. When the recording of the information into the management area 1-B is completed, the record controller 116 records information which is the same as the information recorded in the management area 1-B into the security area X. After the recording of the information into the security area X is completed, the memory manager 108 invalidates the information in the management area 1-A by, for example, destroying the CRC information held by the management area 1-A.

The above writing process will be described in detail below with reference to a flowchart shown in FIG. 8. The communication device 100 receives an updating instruction in step S402. The record controller 116 writes updated data Db′, Dc′ into free data areas in step S404. Thereafter, the record controller 116 writes address information E2 indicative of valid data areas in the data area 206 into the management area 2-B in step S406. The memory manager 108 increments the write counter of the management area 2-B in step S408. Then, the record controller 116 writes address information E3 indicative of valid data areas in the data area 210 into the management areas 3-A in step S410. The memory manager 108 increments the write counter of the management area 3-A in step S412. Thereafter, the record controller 116 writes address information indicative of management areas which will be valid after the data are updated, into the management area 1-B in step S414. The memory manager 108 increments the write counter of the management area 1-B in step S416. After the updating of the data in the management area 1-B is completed, the record controller 116 writes information which is the same as the address information E1 recorded in the management area 1-B into the security area X in step S418. After the writing of the information into the security area X is completed, the memory manager 108 invalidates the information in the management area 1-A. The data updating process is performed according to the above procedure. The restoring process after the reactivation of the data storage device according to the second embodiment is the same as the restoring process according to the first embodiment, and hence is carried out according to the flowcharts shown in FIGS. 5 and 6.

According to the above data updating process, when the data storage device is activated, it is possible to determine which management area is to be validated by checking the information stored in the security area X against the address information recorded in the management area 1-A or the management area 1-B. For example, if the information held by the security area X corresponds to the address information held by the management area 1-A, then the management area setting unit 118 can select the management area 1-A as a valid management area. Furthermore, when the data storage device is activated, the memory manager 108 can determine the recorded state of the security area X by referring to the states of the management area 1-A and the management area 1-B. For example, when the data storage device is activated, if the count of the write counter of the management area 1-A is smaller than the count of the write counter of the management area 1-B and the information in the management area 1-A is invalidated, then the memory manager 108 can judge that the information corresponding to the address information in the management area 1-B has reliably been recorded in the security area X if the security area X is in the normal state. In this case, the management area setting unit 118 selects the management area 1-B as a valid management area.

According to the first and second embodiments described above, the memory manager 108 refers to the write counters to determine whether the address information held by each of the management area is new or old, and thereafter determines the state of the management area which is holding the address information prior to being updated for thereby determining whether the information in the security area X has reliably been recorded or not. The management area setting unit 118 checks the information in the security area X against the address information in management areas to select a management area to be validated. According to the above memory managing method, when the data storage device is activated, the memory manager 108 can determine whether the information held by each management area has reliably been written or not, and can simultaneously determine whether the information held by the security area X has reliably been recorded or not.

With the data storage device according to the second embodiment, the management areas are of a hierarchical structure, and the management areas in the highest level are arranged in a redundant structure to make it possible to record and manage data highly accurately. Particularly, since the size of data areas which can be managed by a management area is limited by a recording medium that is used, it is practical to construct management areas of a hierarchical structure according to the second embodiment if data areas of a large capacity are to be managed. Accordingly, a more practical and safe data recording and management system can be realized by using the memory managing method according to the first embodiment as a basis and applying the memory managing method according to the second embodiment.

While the preferred embodiments of the present invention have been described above with reference to the accompanying drawings, it is obvious that the present invention is not limited to those embodiments. It is clear that those skilled in the art can predict various changes and corrections within the scope of the claims, and those changes and corrections fall within the technical scope of the present invention.

For example, if a data storage device has management areas of a hierarchical structure as with the memory 110 according to the second embodiment, then each of the management areas may have a redundant security area X. In addition, a data area may be subordinate to a management area in a highest level. These arrangements not only make it possible to increase the reliability of stored data, but also can effectively utilize storage areas of the management areas.

In the first and second embodiments, the memory 110 has the two management areas A, B and the security area X. However, the memory 110 may have three or more management areas A, B, C, . . . , and may have a plurality of security areas.

Although certain preferred embodiments of the present invention have been shown and described in detail, it should be understood that various changes and modifications may be made therein without departing from the scope of the appended claims.

What is claimed is:

1. A data storage device comprising:
a memory configured to have first and second management areas for recording address information indicative of valid data areas, and a security area for recording information corresponding to address information recorded in either one of said first and second management areas;
a record controller configured to rewrite information recorded in said security area after the address information recorded in either one of said first and second management areas has been updated, into information corresponding to the updated address information; and
a management area setting unit configured to set either one of said first and second management areas as a valid management area based on the information recorded in said security area.

2. The data storage device according to claim 1, wherein said record controller invalidates the address information recorded in one of said first and second management areas which is not set as said valid management area, after the information recorded in said security area has been rewritten.

3. The data storage device according to claim 2, wherein said management area setting unit determines whether said security area is valid or not based on whether said first management area or said second management area is invalidated or not, when said data storage device is activated.

4. The data storage device according to claim 1, wherein
said memory further includes a plurality of auxiliary management areas configured to record address information indicative of valid data areas, said first and second management areas and said security area, and
said first management area or said second management area records address information indicative of a valid auxiliary management area instead of address information indicative of a valid data area.

5. A method of managing data in a memory having first and second management areas for recording address information indicative of valid data areas, and a security area for recording information corresponding to address information recorded in either one of said first and second management areas, said method comprising the steps of:
updating address information recorded in either one of said first and second management areas;
rewriting information recorded in said security area into information corresponding to the updated address information; and
setting either one of said first and second management areas as a valid management area based on the information recorded in said security area.

6. A program for managing data in a memory having first and second management areas for recording address information indicative of valid data areas, and a security area for recording information corresponding to address information recorded in either one of said first and second management areas, said program enabling a computer to performing the functions of:
updating address information recorded in either one of said first and second management areas;
rewriting information recorded in said security area into information corresponding to the updated address information; and
setting either one of said first and second management areas as a valid management area based on the information recorded in said security area.
